(19) United States
(12) Patent Application Publication
(10) Pub. No.: US 2003/0028859 A1
(43) Pub. Date: Feb. 6, 2003

(54) Method of collecting, visualizing and analyzing object interaction

(76) Inventors: Nigel Street, Swindon (GB); Dave Sellars, Swindon (GB); Andrew McDermott, Swindon (GB)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/919,406

(22) Filed: Jul. 31, 2001

(51) Int. Cl. G06F 9/44

(52) U.S. Cl. 717/125

(57) ABSTRACT

A system and method for collecting and displaying object interaction on a target processor is provided which includes the steps of logging object interaction data on a target processor over a monitoring period, and displaying the object interaction data as a graph, the graph having a plurality of nodes and at least one line, each node being associated with a corresponding object, each line connecting two of the nodes and representing an interaction between the respective objects associated with the two nodes.

### BACKGROUND

U.S. Pat. No. 5,872,909 entitled “Logic Analyzer for Software” relates to a system which logs events that occur in target software and displays status information in a time-line fashion with specific icons indicating events and status changes to show task interaction over time.

This system, which is commercially available as the WindView® product manufactured and distributed by Wind River Systems, Inc., is a development and debugging tool which monitors and collects information which is displayed in a graphical format that shows system conditions in relation to time. Measurement of software performance is accomplished with a host computer that monitors a separate, target computer running the target software whose performance is being assessed.

### SUMMARY OF THE INVENTION

In accordance with a first embodiment of the present invention, a method is provided for collecting and displaying interactions of operating system and application objects on a target processor. The method comprises the steps of logging object interaction data on a target over a monitoring period, and displaying the object interaction data as a graph. The graph has a plurality of nodes and at least one line and each node is associated with a corresponding object. Each line connects two of the nodes and represents an interaction between the respective objects associated with the two nodes.

In accordance with a second embodiment of the present invention, a system is provided which includes a target environment, a display, an executable logging component and an executable graphing component. The executable logging component logs object interaction data on the target processor over a monitoring period. The executable graphing component displays the object interaction data as a graph on the display. The graph has a plurality of nodes and at least one line and each node is associated with a corresponding object. Each line connects two of the nodes and represents an interaction between the respective objects associated with the two nodes.

In accordance with a third embodiment of the present invention, a host computing environment for accepting data from a target environment is provided. The host computing environment includes an executable component which receives, from the target environment, object interaction data for objects executing on the target environment. The executable component displays the object interaction data as a graph on a display and the graph includes a plurality of nodes and at least one line. Each node is associated with a corresponding object. Each line connects two of the nodes and represents an interaction between the respective objects associated with the two nodes.

In accordance with a fourth embodiment of the present invention, a computer readable media is provided which has stored thereon, computer executable process steps operable to control a computer to display object interaction data as a graph on a display, the graph having a plurality of nodes and at least one line, each node being associated with a corresponding object, each line connecting two of the nodes and representing an interaction between the respective objects associated with the two nodes.

In accordance with further embodiments of the present invention, a computer readable medium is provided which has stored thereon computer executable process steps operative to control a computer in the manner described above with regard to the first second, and third embodiments.

### BRIEF DESCRIPTION OF THE DRAWINGS

FIG. 1 shows a diagram of a target and host computer according to an embodiment of the present invention.

FIG. 2 shows an object interaction graph according to a first embodiment of the present invention.

### DETAILED DESCRIPTION OF THE PREFERRED EMBODIMENTS

In accordance with one embodiment of the present invention, a method is provided for collecting and displaying operation information of a target process. A monitoring system resides on a host computer operably connected to a target system. Particular system events of the processes on the target system are logged over a predetermined time period to create a system log. The log is uploaded to the host to reconstruct the interaction of operating system objects in the target process. The reconstructed object interaction is displayed as a graph of nodes, each node representing an object, and a number of lines, each line representing an interaction between objects.

As mentioned above, the WindView development tool includes a host computing environment which is coupled to a target device or environment. In accordance with the above-referenced embodiment of the present invention, a new visualization and analysis technique is used in graphing and displaying computer system data that allows an overview of operating system object interaction to be provided. A log of system activity on a target computer is kept for a certain duration and processed to construct a network of object interaction over the duration of the log. The object interaction data is then presented as a graph of interactions. In addition, the data can be queried to verify assertions. For example, if a user wishes to confirm that object A does not interact with object B, he or she could query the log to determine if any such interaction has been recorded. Presenting system information in this way, a summary of interaction between system components is provided making it possible to analyze a system from a new and different perspective. In certain embodiments of the present invention, the system in accordance with the present invention utilizes the logs generated by commercially available development tools such as the WindView 1.0 or WindView 2.0 development tool manufactured by Wind River Systems, Inc. or the Linux Trace Toolkit available through Opersys, Inc. and Lineo, Inc. (www.opersys.com/LTT).

The system can be implemented by itself, or in addition to a pre-existing software performance monitoring system to provide additional information and perspective on a particular system independent of time. In accordance with this embodiment of the present invention, the focus is not on the state of a target system at a specific time, but rather, how the target system components interact over a period of time.

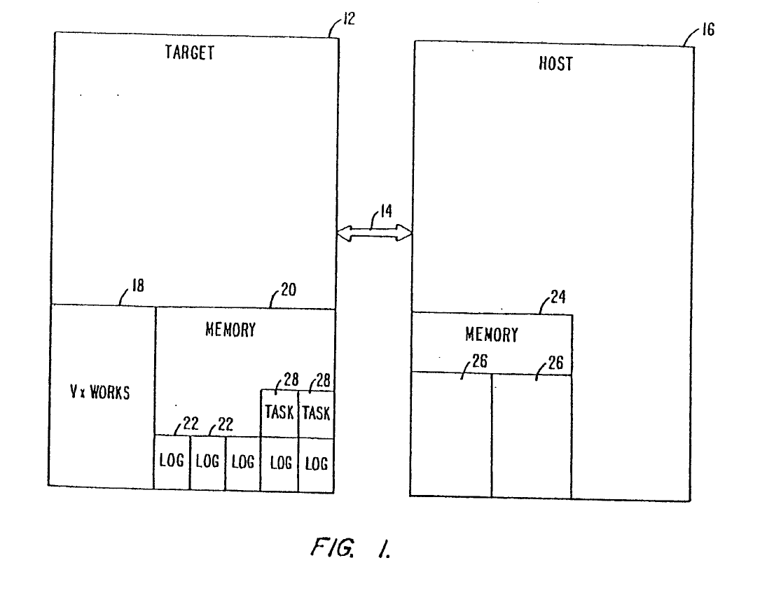

FIG. 1 illustrates a target device 12 connected via a link 14 to a host computer 16. The target computer includes an operating system 18, such as the VxWorks® operating system of Wind River Systems, Inc. A memory 20 includes a buffer for storing one or more logs of object interactions 22, which may be periodically uploaded to host 16 via link 14. Host 16 includes a memory 24 with reconstructed data fields 26. Data fields 26 are reconstructed from the logs 22 to provide a display of object interactions over a monitoring period. The logged object interactions of the target device 12 may include switching from one task 28 to another, a change in the state of a task, the giving or taking of a semaphore, accessing a particular resource, or any other interaction which the user desires to analyze. The different tasks (individually executable programs) are stored on the target computer in memory 20, indicated as tasks 28, and are run as needed or scheduled. Target device 12 could be a separate traditional stand-alone computer, or could be an embedded computer board that is plugged into a car, printer, etc.

Link 14 is preferably an ethernet link, using TCP-IP protocol. Alternately, link 14 can be a connection over an in-circuit or ROM emulator, a serial line or any other known method of point-to-point communication. Host 16 may, for example, be a workstation running a Unix® or Unix® based operating system, or a PC running a Windows® or Linux operating system.

In addition to the target-and-host structure set forth above, aspects of the present invention are useful where a single computer runs both the target and host software. An example is a multi-tasking environment running on a workstation with plenty of power and memory. The uploading bandwidth is not a constraint in this environment, but the lack of intrusiveness and the ability to provide the status and object interaction display are very useful.

As the target device 12 operates, the actions taken by each object over a monitoring period are recorded and maintained in a log by a software object. In the system of FIG. 1, the log is maintained on the target device 12, and is uploaded to the host computer 16 after the monitoring period. However, it is also possible for the log to be uploaded periodically during the monitoring period. Moreover, it is also possible to continuously upload the actions taken by each object to the host computer 16 (in effect, uploading one object interaction log at a time), and to maintain the log of the actions over the monitoring period only on the host computer. In any event, after the monitoring period, the information in the log is processed to create a object interaction graph. It should be noted that the log may contain information on all types of object interactions and when processed, a sub-set of specific object interactions may be selected for the graph.

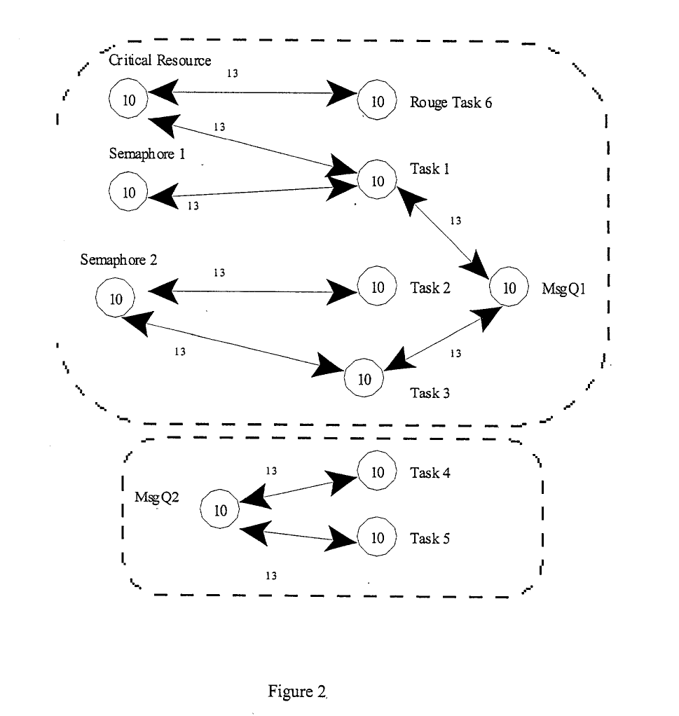

FIG. 2 shows an illustrative object interaction graph. A number of nodes 10 are connected by lines 13. Each node 10 represents an object, which may, for example, include tasks, semaphores, message queues, timers, and user instrumented objects. A connection between two nodes 10 via a line 13 indicates that, during the monitoring period of the graph, the objects represented by the nodes have interacted. The direction of an interaction can, for example, be indicated with via arrows, with double arrows indicating a bidirectional interaction. For example, FIG. 2 indicates that, during the monitoring period, task 1 interacted with semaphore 1 (for example, by giving and or taking the semaphore). The use of double arrows for this interaction, could, for example, be defined as indicating that the task 1 gave (arrow from task 1 to semaphore 1) and took (arrow from semaphore 1 to task 1) the semaphore 1.

In this regard, a task is an independently running program on the target device, and an ISR can be viewed as a task which handles interrupts. An event is any action undertaken by a task or an interrupt service routine that provides information or affects the state of the system. Examples of events are semaphore gives and takes, task spawns, and deletions, timer expirations and interrupts. Objects may fall into categories such as the following: exception and ISR; message queue; semaphore; signal; task; tick; user event; watchdog timer and unknown. Instrumentation of the above-referenced objects can be implemented in the application code on the target device 12. It should be noted that the term “object” or “component”, as used herein, is meant to generically refer to the software components managed by the operating system, and is not limited to objects in operating systems, such as VxWorks, which are coded in an object oriented programming language with tasks, interrupt service routines (ISRs), events, and memory implemented as objects.

In any event, the WindView 2.0 development tool includes a built in set of instrumented objects, and also allows the developer to provide instrumentation of other objects by adding instructions implementing the instrumentation in the application code on the target device. In WindView 2.0, the objects that can be instrumented (e.g., logged) are tasks, semaphores, watchdog timers, message queues, signals, and memory calls. WindView 2.0 allows a developer to enable instrumentation programmatically for a particular object, such as task t1, or a group of objects, such as all semaphores. Combinations of objects can also be instrumented: for example, the user might be interested in how task t1, all semaphores, and message queues mq1 and mq2 interact.

The WindView 2.0 development tool stores event information in the log buffer (holding logs of events 22) on the target device each time an event occurs. The target breaks away from the current instruction stream of the task, ISR or idle loop, copies data describing the event into the buffer and then returns to running the task, ISR or idle loop. However, a context switch may occur as a result of the logged event. In this circumstance, the target will resume execution in some other task or ISR—or even in the idle loop if it was not executing there before the event. Event logging is enabled by the user, and the amount of data generated, and thus the amount of time consumed by the generation and storage of the data depends on the event logging mode. WindView 2.0 includes three event logging modes, the CSE level, the TST level, and the AIL level. The CSE level is the lowest level of logging, and logs events which cause context switches. At the next logging level, the TST level, events causing task state transitions, which are generated only by kernel objects, are collected. At the highest logging level, the AIL level, all the context switch and task state transition events are collected.

The events logged in WindView may include task events, watchdog timer events, semaphore events, message queue events, memory call events and signal events. Task events can, for example, include creating, deleting, delaying, setting the priority of, suspending and resuming tasks, as well as making tasks safe from deletion and making tasks deleteable. Events may also include pending or unpending a task which is attempting to delete a task safe from deletion. Semaphore events in the objects status mode include creating a binary, counting or mutex semaphore; deleting, giving or taking a semaphore; flushing all tasks pended on a semaphore; and giving a mutex semaphore with force. Watchdog timer events include creating, deleting, starting and cancelling a watchdog timer. Message queue events include creating, deleting, receiving and sending a message. Signal events in the object status mode include setting a signal handler, suspending or pausing a task until signal delivery, sending a signal to a task and executing in a signal handler. Memory call events may include accessing, reading or writing from a specified memory resource.

Each event as logged in WindView has a fixed format: an event ID, followed by a parameter array. Some events have a time stamp between the event ID and the parameter array. An event ID is a fixed-length identifier uniquely determining the type of event the log entry represents. The target and host are in agreement as to the fixed-length and as to which specific event IDs represent which specific events. The time stamp is a fixed-length identifier indicating the time at which the event was logged. Again, the target and hosts agree as to the length of a time stamp and the format of the time in the time stamp field. In the interest of optimization, the time stamp field may be omitted for certain events. The third component of an event log entry is a parameter array of variable length. The length of the array is determined by the type of event and therefore the amount of information which must be recorded to log that type of event.

The graphing system of the present invention can utilize existing logs, such as WindView or Linux Trace Toolkit logs, or a different type of log can be generated on the target to build up interaction data. In this regard, it should be noted that WindView and Linux Trace Toolkit logs (LTT logs), being designed to provide a time line of events occurring on tasks, record event specific information such as time stamps which are not necessary for the object interaction graph of FIG. 2. Rather, an object interaction graph can be generated as long as the system records that an interaction has occurred during the monitoring period. Existing WindView or Linux Trace Toolkit logs log each individual event to record the event-timeline. The size of the buffer for storing the logged information is therefore proportional to the monitoring period. In contrast, the information needed to generate an object interaction graph is finite in that it is limited to a small data item (potentially as small as one bit) per object interaction. Subsequent interactions between these objects can be recorded in the same data item. Even if additional information, such as the number of interactions occurring during a monitoring period, is recorded, the size of the required buffer can remain finite. For example, such additional information could be provided by recording each object interaction pair as a counter that is incremented each time an interaction occurs between the objects in the pair. Moreover, an interaction flag or counter could similarly be used to represent the direction of the interaction between the two objects in the object pair. Therefore, by providing a log which includes only the information needed to provide an object interaction graph, the log can include data for longer monitoring times than the pre-existing WindView and LTT logs. With any of these techniques, however, statistics on the number of interactions and directions of interactions can be maintained if desired.

When implemented in a graphical user interface (GUI), the nodes can include clickable objects that would display interaction details when a specific node is clicked. In addition, graphical characteristics of the node can be made to correspond to a legend where the size or color of the node, or the connecting line, could be used to visualize the degree of object interaction. In addition, queries may be performed on the interaction data, for example, via scripts or at the command line, to verify assertions about system behavior or to determine specific operating conditions.

Referring to FIG. 2, the lines 13 represent interaction between objects over a monitoring period. For purposes of this discussion, it will be assumed that the presence of arrows on the lines is merely ornamental, and is not intended to indicate a direction of interaction. In the exemplary display shown in FIG. 2, the system is configured to show tasks 1 through 6, semaphores 1-2, message queues 1-2, and a critical resource (e.g., a particular memory access). From a review of this display, the developer can learn a number of things about the interaction of these various objects during the monitoring period. For example, the developer can determine that tasks 1 and 3 interacted with the message queue 1 at some time during the monitoring period, but that tasks 2, 4-6 did not. In contrast, tasks 4 & 5 interacted with the message queue 2 during the monitoring period, but tasks 1-3, and 6 did not.

The developer can also determine that both tasks 1 and 6 accessed the critical resource during the monitoring period, but that only task 1 interacted with a semaphore (semaphore 1). With this information, the developer can identify the possible existence of a race condition, because the task 6 has accessed the critical resource without invoking a semaphore. It should be noted that although FIG. 2 shows a semaphore 1 object, without indicating whether the semaphore was a given (e.g. semGive( )), taken (e.g. semTake( )), or both, the system could be configured to separately display the semaphore “give” and the semaphore “take” as separate nodes. Alternatively, the system can be configured to indicate whether the semaphore was given, taken, or both given and taken, when for example, the semaphore 1 node of FIG. 2 is clicked on.

The object interaction graph of FIG. 2 can also be used as a development tool for identifying objects which are isolated from each other. For example, in the exemplary display shown in FIG. 2, task 4, task 5, and message queue 2 do not interact with the remaining nodes on the graph, thereby indicating the presence of two closed systems (as indicated by the dashed lines). With this information, the developer may wish to isolate task 4, task 5, and message queue 2 from the other objects (for example, to enhance security). For example, in Wind River's VxWorks AE operating system, this isolation could be implemented using protection domains. In this manner, visualizing system object interaction according to the present invention shows the presence of closed systems so that they may be spotted quickly and easily to determine what objects, if any, should be moved to a separate protection domain to increase efficiency and reliability.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for collecting and displaying object interaction on a target comprising the steps of:
logging object interaction data on a target over a monitoring period;
displaying the object interaction data as a graph, the graph having a plurality of nodes and at least one line, each node being associated with a corresponding object, each line connecting two of the nodes and representing an interaction between the respective objects associated with the two nodes.

2. The method of claim 1, wherein the displaying step comprises displaying the graph on a host computing environment, and wherein the method further comprises the step of, prior to the displaying step, uploading the logged object interaction data from the target to the host computing environment.

3. The method of claim 1, wherein the object interaction data is operating system object interaction data.

4. The method of claim 1, wherein the step of logging object interaction data comprises recording interactions between operating system objects, the operating system objects including one or more of a semaphore, an ISR, a task and a memory call.

5. The method of claim 1, wherein each line is terminated with at least one arrow.

6. The method of claim 5, wherein each arrow on each line is indicative of a direction of interaction between the two nodes connected by said each line.

7. The method of claim 1, further comprising the step of accepting, as input from a user, a query for information regarding the logged object interaction data, and displaying information responsive to the query to the user.

8. The method of claim 1, wherein the logging step is performed by a WindView development tool.

9. The method of claim 8, wherein the WindView development tool is a WindView 2.0 development tool.

10. The method of claim 9, wherein the WindView development tool is a WindView 1.0 development tool.

11. The method of claim 1, wherein the logging step is performed by a Linux Trace Toolkit development tool.

12. A system comprising:
a target environment;
a display;
an executable logging component, the executable logging component logging object interaction data on the target environment over a monitoring period;
an executable graphing component, the executable graphing component displaying the object interaction data as a graph on the display, the graph having a plurality of nodes and at least one line, each node being associated with a corresponding object, each line connecting two of the nodes and representing an interaction between the respective objects associated with the two nodes.

13. The system of claim 12, wherein the executable logging component executes in the target environment.

14. The system of claim 12, wherein the executable graphing component and the executable logging component both execute on a common processor.

15. The system of claim 12, further comprising a host computing environment coupled to the target environment and to the display, the executable graphing component executing on the host computing environment.

16. The system of claim 15, wherein the executable logging component executes on the target environment.

17. The system of claim 16, wherein host computing environment uploads the logged object interaction data from the target environment.

18. The system of claim 12, wherein the object interaction data is operating system object interaction data.

19. The system of claim 12, wherein the executable logging component records interactions between operating system objects, the operating system objects including one or more of a semaphore, an ISR, a task and a memory call.

20. The system of claim 12, wherein each line is terminated with at least one arrow.

21. The system of claim 20, wherein each arrow on each line is indicative of a direction of interaction between the two nodes connected by said each line.

22. The system of claim 12, wherein the executable graphing component accepts, as input from a user, a query for information regarding the logged object interaction data, and displays information responsive to the query to the user.

23. The system of claim 12, wherein the executable logging component is a component of a WindView development tool.

24. The system of claim 23, wherein the WindView development tool is a WindView 2.0 development tool.

25. The system of claim 23, wherein the WindView development tool is a WindView 1.0 development tool.

26. The system of claim 12, wherein the executable logging component is a component of a Linux Trace Toolkit development tool.

27. A host computing environment for accepting data from a target processor, comprising:
an executable component for executing on a host computing environment, the component receiving, from a target environment, object interaction data for objects executing in the target environment, the executable component displaying the object interaction data as a graph on the display, the graph having a plurality of nodes and at least one line, each node being associated with a corresponding object, each line connecting two of the nodes and representing an interaction between the respective objects associated with the two nodes.

28. The host computing environment of claim 27, wherein each line is terminated with at least one arrow.

29. The host computing environment of claim 28, wherein each arrow on each line is indicative of a direction of interaction between the two nodes connected by said each line.

30. The system of claim 27, wherein the executable component accepts, as input from a user, a query for information regarding the logged object interaction data, and displays information responsive to the query to the user.

31. A computer readable media, having stored thereon, computer executable process steps operable to control a computer to display object interaction data as a graph on a display, the graph having a plurality of nodes and at least one line, each node being associated with a corresponding object, each line connecting two of the nodes and representing an interaction between the respective objects associated with the two nodes.

32. The method of claim 1, further comprising the steps of:
identifying isolated objects based upon the logged interaction data; and
generating a protection domain for the isolated objects.

33. The method of claim 32, wherein the protection domain is a VxWorks AE protection domain.
